(19) United States
(12) Patent Application Publication
(10) Pub. No.: US 2016/0288087 A1
(43) Pub. Date: Oct. 6, 2016

(54) ACTIVATED CARBON FOR ADSORBING GAS-PHASE

(71) Applicant: Kuraray Chemical Co., Ltd., Bizen-shi (JP)

(72) Inventors: Mitsunori HITOMI, Bizen-shi (JP); Takayuki Yamada, Bizen-shi (JP)

(73) Assignee: Kuraray Chemical Co., Ltd., Bizen-shi (JP)

(21) Appl. No.: 15/082,074

(22) Filed: Mar. 28, 2016

(30) Foreign Application Priority Data
Mar. 30, 2015 (JP) 2015-069431

(51) Int. Cl. B01J 20/20; A62B 18/02; A62B 23/02; B01J 20/28

(52) U.S. Cl. CPC B01J 20/20; B01J 20/28088; B01J 20/28004; A62B 18/02; A62B 23/02

(57) ABSTRACT

Activated carbon for adsorbing a gas phase is provided, wherein the activated carbon has a maximal peak value of 11 Å or larger in a pore size distribution measured using a water vapor adsorption method.

### CROSS REFERENCE TO RELATED APPLICATION

The present application claims the Paris Convention priority based on Japanese Patent Application No. 2015-69431 filed on Mar. 30, 2015, the entire content of which is incorporated herein by reference.

### TECHNICAL FIELD

The disclosure relates to activated carbon for adsorbing a gas phase, whose amount adsorbed of water is reduced and that has excellent adsorption performance for organic gas and, more particularly, to activated carbon for a gas mask.

### BACKGROUND OF THE INVENTION

Activated carbon has an excellent capability to adsorb various types of hazardous substances and malodorous substances, and has traditionally been used as an adsorbent in many fields for domestic uses or industrial uses (JP 2006-167621 A and JP 3612329 B). Activated carbon has excellent adsorption performance for various compounds such as chlorine-based gases, acid gases and organic compounds, is therefore especially useful as an adsorbent for a gas phase, and is usable as, for example, a deodorant, filters for a gas mask, exhaust gas collection, and air conditioning, and the like.

SUMMARY OF THE DISCLOSURE

In one embodiment of the invention, activated carbon that has a maximal peak value of 11 Å or larger in a pore size distribution measured using a water vapor adsorption method is provided.

### DETAILED DESCRIPTION

When activated carbon is used in a gas mask and the like, especially high adsorption performance is required to protect the user. Activated carbon however adsorbs not only the hazardous substances but also moisture, and therefore adsorbs much moisture under a condition of high humidity. Thus, a problem arises that activated carbon cannot sufficiently adsorb the hazardous substance to originally be adsorbed.

An object of the present invention is to provide activated carbon for adsorbing a gas phase, whose amount adsorbed of water is reduced and that has excellent adsorption performance for organic gases even under a condition of high humidity.

The inventors found that the object can be achieved by using activated carbon that has a maximal peak value of 11 Å or larger in a pore size distribution measured using a water vapor adsorption method, and completed the present invention.

The present invention includes preferred embodiments as below.
[1] Activated carbon for adsorbing a gas phase, having a maximal peak value of 11 Å or larger in a pore size distribution measured using a water vapor adsorption method.
[2] The activated carbon for adsorbing a gas phase according to [1], wherein the activated carbon has carbon tetrachloride adsorption performance of 70% or higher.
[3] The activated carbon for adsorbing a gas phase according to [1] or [2], wherein the activated carbon has a particle size in a range from 4 mesh to 150 mesh.
[4] The activated carbon for adsorbing a gas phase according to anyone of [1] to [3], wherein a raw material of the activated carbon is a coconut shell.
[5] A gas mask comprising the activated carbon for adsorbing a gas phase according to any one of [1] to [4].

The activated carbon for adsorbing a gas phase according to one embodiment of the present invention has a reduced amount adsorbed of water, and has excellent adsorption performance even under a condition of high humidity. The activated carbon is therefore advantageously usable as an adsorbent for a gas phase and is especially useful to be used in a gas mask and the like.

Embodiments of the present invention will be described below.

Activated carbon for adsorbing a gas phase according to one embodiment of the present invention is activated carbon whose main raw material is carbon precursor. The carbon precursor, which is the raw material of the activated carbon for adsorbing a gas phase according to one embodiment of the present invention, is not especially limited only when the carbon precursor forms activated carbon by being carbonized and activated, and can widely be selected from those based on plants, those based on minerals, natural materials, synthesized materials and the like. Examples of the plant-based carbon precursors include wood, charcoal, rice hull, and fruit shells such as a coconut shell and a palm shell. Examples of the mineral-based carbon precursors include petroleum-based pitch, coal-based pitch and coke. Examples of the natural material-based carbon precursors include natural fibers such as cotton and linen, regenerated fibers such as rayon and viscose rayon, and semisynthetic fibers such as acetate and triacetate. Examples of the synthesized material-based carbon precursors include polyamide-based resins such as nylon, polyvinylalcohol-based resins such as vinylon, polyacrylonitrile-based resins such as acrylic resins, polyolefin-based resins such as polyethylene and polypropylene, polyurethane, phenol-based resins, and vinyl chloride-based resins. Among them, a coconut shell is preferably used as the raw material of the activated carbon, in view that the coconut shell does not include any hazardous impurities, that the coconut shell can easily be commercially acquired, and that it is easy to produce activated carbon having a narrow pore size distribution.

The activated carbon for adsorbing a gas phase according to one embodiment of the present invention has a maximal peak value of 11 Å or larger, preferably 11.5 Å or larger, and more preferably 12 Å or larger, in a pore size distribution measured using a water vapor adsorption method. The activated carbon for adsorbing a gas phase according to one embodiment of the present invention has a maximal peak value of, preferably 15 Å or smaller, and, more preferably 14 Å or smaller, in the pore size distribution measured using the water vapor adsorption method. When the maximal peak value in the pore size distribution is equal to the smaller limit value or larger, the amount of water adsorbed by the activated carbon is reduced and the adsorption performance for organic gases is advantageously improved. When the maximal peak value in the pore size distribution is equal to the larger limit value or smaller, the packing amount of the activated carbon in a gas mask and the like can be increased and high adsorption performance can advantageously be achieved.

The pore size distribution of activated carbon can be acquired from a pore size distribution curve based on the water vapor adsorption method. The pores of activated carbon each have a pore radius equal to or smaller than the pore radius (r) acquired based on the Kelvin equation represented by the following Equation (I) from the value (P) of the saturated vapor pressure of water at 1 atmospheric pressure (the absolute pressure) and at 30° C. specific to the concentration of sulfuric acid in a sulfuric acid aqueous solution. The accumulated pore volume of the pores whose radii are each equal to or smaller than the pore radius acquired based on the Kelvin equation is the volume of water at 30° C. that corresponds to the saturated adsorption amount determined by the measurement test.

r=−[2Vmγ cos φ]/[RT ln(P/P₀)] (I)

r: Pore radius (cm)

Vm: Molecular volume of water (cm³/mol)=18.079 (30° C.)

γ: Surface tension of water (dyne/cm)=71.15 (30° C.)

φ: Contact angle between a capillary wall and water (°)=55°

R: Gas constant (erg/deg·mol)=8.3143×10⁷

T: Absolute temperature (K)=303.15

P: Saturated vapor pressure (mmHg) exhibited by water in the pores

P₀: Saturated vapor pressure (mmHg) of water at 1 atmospheric pressure (the absolute pressure) and at 30° C.=31.824

A measurement test of the saturated adsorption amount is conducted for each of 13 types of sulfuric acid aqueous solution whose sulfuric acid concentrations are varied from each other (11 types of sulfuric acid aqueous solution having specific gravities from 1.05 to 1.30 at intervals of 0.025, a sulfuric acid aqueous solution having a specific gravity of 1.35, and a sulfuric acid aqueous solution having a specific gravity of 1.40) and, in the measurement test, the accumulated pore volume is determined for the pores each having a radius equal to or smaller than the corresponding pore radius. Each of the accumulated pore volume determined in this manner is plotted against the pore radius, and the pore size distribution curve of the activated carbon can thereby be determined. The radius exhibiting a local maximal value in the pore size distribution curve is taken as the maximal peak value.

The activated carbon for adsorbing a gas phase according to one embodiment of the present invention has adsorption performance for carbon tetrachloride (CTC) of, preferably 70% or higher, more preferably 80% or higher, and further preferably 85% or higher. When the CTC adsorption performance of the activated carbon for adsorbing a gas phase according to one embodiment of the present invention is equal to or higher than the lower limit values, the activated carbon is excellent in the adsorption performance for organic gases and can therefore advantageously be used as an adsorbent for a gas phase of a gas mask and the like. Although the activated carbon for adsorbing a gas phase according to one embodiment of the present invention can more advantageously adsorb organic gases as the CTC adsorption performance thereof is higher, the CTC adsorption performance thereof is usually 95% or lower.

In the present invention, the CTC adsorption performance can be measured using a method defined in ASTM D3467.

The shape of the activated carbon for adsorbing a gas phase according to one embodiment of the present invention is not especially limited, and examples thereof include fibrous carbon, crushed carbon, granular carbon, spherical carbon, and the like. Among them, crushed carbon, granular carbon, and spherical carbon are preferably used.

The particle size of the activated carbon for adsorbing a gas phase according to one embodiment of the present invention is, preferably from 4 mesh to 150 mesh, more preferably from 8 mesh to 30 mesh, and further preferably from 10 mesh to 20 mesh. When the particle size of the activated carbon according to one embodiment of the present invention is within the above ranges, the airflow resistance is advantageously excellent for use in a gas mask.

As to the average particle size of the activated carbon according to one embodiment of the present invention, D₅₀ is preferably 2,000 μm or smaller, and more preferably 1,500 μm or smaller. From the viewpoint of the airflow resistance, it is advantageous that D₅₀ of the activated carbon for adsorbing a gas phase according to one embodiment of the present invention is equal to the upper limit values or smaller. D₅₀ of the activated carbon for adsorbing a gas phase according to one embodiment of the present invention is usually 300 μm or larger. “D₅₀” is a particle size when, in the particle size distribution, 50% of the number or the mass of all of the particles is occupied by that of particles having greater/larger than the particle size.

As to the specific surface area of the activated carbon, the activated carbon having the specific surface area of, preferably 500 to 2,500 m²/g or larger, and more preferably about 700 to about 2,000 m²/g is used. When the specific surface area of the activated carbon is within the above ranges, the activated carbon advantageously tends to achieve the original adsorption performance thereof for organic gases.

The activated carbon for adsorbing a gas phase according to one embodiment of the present invention can be produced by carbonizing and activating the carbon precursor. The condition for the carbonization is not especially limited and, for example, in a case of the carbon precursor in particles, a condition that the process is conducted in a batch rotary kiln at a temperature of 300° C. or higher with a small amount of inert gas flowing therein or the like may be employed.

The activated carbon can be acquired by activating the carbonized carbon precursor after carbonizing the carbon precursor, and any method such as gas activation or chemical agent activation may be used as the activation method. In view of acquisition of the activated carbon having high mechanical strength and having high adsorption performance, the gas activation method is preferably used. A gas used in the gas activation method is not especially limited, and the various physical properties of the acquired activated carbon are not significantly varied depending on the type of the used gas. Examples of the gas used in the gas activation method include water vapor, carbon dioxide, oxygen, an LPG combustion gas, and a mixture gas of these. Taking into consideration the safety and the reactivity, a water vapor-containing gas having water vapor of 10 to 50% by volume is preferably used.

The activation temperature is from 700 to 1200° C., and preferably from 800 to 1,100° C. Any activation furnace may be used only when the activation furnace causes the reaction to be evenly conducted, and any of various types of activation furnace is usable. A rotary kiln, a flow furnace, a Herreshoff furnace, a sleeve furnace, or the like are usable as the activation furnace.

When the detention time period is long in the activation process, the activated carbon having the pore size distribution according to one embodiment of the present invention can easily be acquired. In the present invention, the activation process is preferably conducted using a rotary kiln or a sleeve furnace with which a long detention time period is available. From the viewpoint of acquisition of the activated carbon having a large pore size, the detention time period is preferably from 7 hours or longer, more preferably from 8 hours or longer, and further more preferably from 10 hours or longer, and the activation process is preferably conducted for a time period that is within 30 hours from the industrial viewpoint.

The activated carbon acquired by the activation may be used as such, and may also be used after removing adhering components by acid washing, water washing, and the like.

The activated carbon acquired in this manner has a form such as particles, sheets, and the like corresponding to the form of the carbon precursor, and is therefore used after being crushed. The crushing means is not especially limited, and any known crushing means is usable such as a cone crusher, a double roll crusher, a disc crusher, a rotary crusher, a ball mill, a centrifugal roller mill, a ring roll mill, various types of centrifugal ball mill crusher, or a roll mill.

A post-process may be applied to the activated carbon for adsorbing a gas phase according to one embodiment of the present invention depending on the use thereof, examples of the post-process include a process of applying a thermal treatment, a process of chemically modifying the surface thereof, and a process of causing the surface thereof to physically hold a functional substance. Examples of the surface modification include impregnation of a salt or an oxide of a metal such as silver or iron, or a mineral acid.

The activated carbon for adsorbing a gas phase according to one embodiment of the present invention is usable as an adsorbent for a gas phase. The activated carbon for adsorbing a gas phase according to one embodiment of the present invention can adsorb organic gases. Examples of the organic gas include volatile aliphatic hydrocarbons such as methane and butane, volatile alicyclic hydrocarbons such as cyclohexane, volatile aromatic hydrocarbons such as benzene and toluene, and chlorine-based compounds such as chloroform. The using method of activated carbon for adsorbing a gas phase according to one embodiment of the present invention is not especially limited, and the activated carbon is usable for a gas mask, collection of solvents, a deodorant, an automobile fuel evaporation preventing apparatus and the like, after being charged in, for example, a cartridge or an absorption canister. Especially, the activated carbon for adsorbing a gas phase according to one embodiment of the present invention can have high adsorption performance for organic gases even under a condition of high humidity, and is therefore advantageously usable as activated carbon for a gas mask.

### EXAMPLES

The present invention will be described in more detail with reference to Examples and Comparative Examples while the present invention is not limited at all by those.

### Example 1

In a batch-type rotary kiln, 1 kg of coconut shell carbide having a particle size of 8/16 mesh was applied with an activation process for 10 hours using water vapor having a water vapor partial pressure of 30% at an activation temperature of 920° C., to obtain an activated carbon (1).

### Example 2

The same operation was conducted as that of Example 1 except that the activation temperature was 940° C., to obtain an activated carbon (2).

### Example 3

The same operation was conducted as that of Example 1 except that the time period of the activation process was 13 hours, to obtain an activated carbon (3).

### Example 4

The same operation was conducted as that of Example 1 except that the time period of the activation process was 16 hours, to obtain an activated carbon (4).

### Example 5

The same operation was conducted as that of Example 1 except that coconut shell carbide having a particle size of 20/50 mesh was used, to obtain an activated carbon (5).

### Example 6

The same operation was conducted as that of Example 1 except that coconut shell carbide having a particle size of 60/150 mesh was used, to obtain an activated carbon (6).

### Example 7

The same operation was conducted as that of Example 1 except that the time period for the activation process was 8 hours, to obtain an activated carbon (7).

### Comparative Example 1

In a batch-type flow furnace, 500 g of coconut shell carbide having a particle size of 8/16 mesh was applied with an activation process for 3 hours using a mixture gas of an LPG combustion gas and water vapor at an activation temperature of 920° C., to obtain an activated carbon (8).

### Comparative Example 2

The same operation was conducted as that of Example 1 except that the time period of the activation process was 6 hours, to obtain an activated carbon (9).

The CTC adsorption performance, the average particle size, and the maximal peak value in the pore size distribution were measured for each of the activated carbons (1) to (9) obtained in Examples 1 to 7 and Comparative Examples 1 and 2. Each of the measurement was conducted according to the above methods. The particle size was determined by using predetermined screens.

The packing density of each of the activated carbons (1) to (9) was measured according to the method defined in ASTM D2854. The weight corresponding to 100 mL of the activated carbon was weighed from the measured value, and was charged in a cartridge having a cylinder-like shape whose inner diameter was 78 mm and whose height was 25 mm. The packing density and the service life performance (amount adsorbed of water, EQOVSL) in this case were also measured. The results thereof are shown in Table 1.

The service life performance (amount adsorbed of water, EQOVSL) can be measured according to the following methods.

### Amount Adsorbed of Water

The amount adsorbed of water was measured by leaving the cartridge having the activated carbon charged therein, untouched for 6 hours in an environment whose humidity was 85%, and measuring thereafter the amount of water adsorbed by the activated carbon.

### EQOVSL

EQOVSL was measured by leaving the cartridge having the activated carbon charged therein, untouched for 6 hours in an environment whose humidity was 85%, and applying thereafter 1000-ppm cyclohexane to the cartridge to measure the time period taken until 5 ppm thereof was permeated. The activated carbon is more excellent in the adsorption performance for organic gases under a condition of high humidity as this value becomes higher. EQOVSL is preferably 110 minutes or longer.

TABLE 1

| | | | | | Average | | SL Performance | |
|---|---|---|---|---|---|---|---|---|
| | | | CTC | | Particle | Pore | Amount | |
| | | Packing | Adsorption | Particle | Size | Size | Adsorbed | |
| | | Density | Performance | Size | (D₅₀) | Peak | of Water | EQOVSL |
| | | g/mL | % | mesh | μm | Å | % | minute |
| Example | 1 | 0.440 | 85.8 | 10-20 | 1298 | 12.94 | 20.68 | 129 |
| | 2 | 0.419 | 87.3 | 10-20 | 1266 | 13.41 | 19.89 | 134 |
| | 3 | 0.409 | 86.3 | 10-20 | 1259 | 14.13 | 19.03 | 130 |
| | 4 | 0.405 | 90.1 | 10-20 | 1241 | 14.88 | 19.33 | 128 |
| | 5 | 0.418 | 86.1 | 20-50 | 500 | 12.13 | 19.10 | 138 |
| | 6 | 0.429 | 85.9 | 60-150 | 153 | 12.88 | 20.06 | 133 |
| | 7 | 0.445 | 80.5 | 10-20 | 1249 | 12.83 | 22.58 | 120 |
| Comparative | 1 | 0.421 | 85.9 | 10-20 | 1229 | 10.86 | 24.1 | 98 |
| Example | 2 | 0.450 | 68.9 | 10-20 | 1277 | 10.58 | 26.1 | 81 |

From the above result, it is apparent that the activated carbons (1) to (7) ontained in Examples 1 to 7 were each able to achieve high adsorption performance even under a condition of high humidity, because the amount adsorbed of water of each thereof was suppressed and simultaneously the EQOVSL of each thereof was long.

On the other hand, the activated carbons (8) and (9) obtained in Comparative Examples 1 and 2 each had degraded service life performance, because the amount adsorbed of water of each thereof was high and the EQOVSL of each thereof was short. The activated carbons (8) and (9) were unable to solve the problem of the present invention.

The activated carbon for adsorbing a gas phase according to one embodiment of the present invention has a reduced amount adsorbed of water and has excellent adsorption performance even under a condition of high humidity. The activated carbon is therefore advantageously usable as an adsorbent for a gas phase and is especially advantageously usable in a gas mask and the like.

What is claimed is:

1. Activated carbon for adsorbing a gas phase, having a maximal peak value of 11 Å or larger in a pore size distribution measured using a water vapor adsorption method.

2. The activated carbon for adsorbing a gas phase according to claim 1, wherein the activated carbon has carbon tetrachloride adsorption performance of 70% or higher.

3. The activated carbon for adsorbing a gas phase according to claim 1, wherein the activated carbon has a particle size in a range from 4 mesh to 150 mesh.

4. The activated carbon for adsorbing a gas phase according to claim 1, wherein a raw material of the activated carbon is a coconut shell.

5. A gas mask comprising the activated carbon for adsorbing a gas phase according to claim 1.

6. The activated carbon for adsorbing a gas phase according to claim 2, wherein the activated carbon has a particle size in a range from 4 mesh to 150 mesh.

7. The activated carbon for adsorbing a gas phase according to claim 2, wherein a raw material of the activated carbon is a coconut shell.

8. The activated carbon for adsorbing a gas phase according to claim 3, wherein a raw material of the activated carbon is a coconut shell.

9. The activated carbon for adsorbing a gas phase according to claim 6, wherein a raw material of the activated carbon is a coconut shell.

10. The gas mask according to claim 5, wherein the activated carbon has carbon tetrachloride adsorption performance of 70% or higher.

11. The gas mask according to claim 5, wherein the activated carbon has a particle size in a range from 4 mesh to 150 mesh.

12. The gas mask according to claim 5, wherein a raw material of the activated carbon is a coconut shell.

13. The gas mask according to claim 10, wherein the activated carbon has a particle size in a range from 4 mesh to 150 mesh.

14. The gas mask according to claim 10, wherein a raw material of the activated carbon is a coconut shell.

15. The gas mask according to claim 11, wherein a raw material of the activated carbon is a coconut shell.

16. The gas mask according to claim 13, wherein a raw material of the activated carbon is a coconut shell.
